(19) United States
(12) Patent Application Publication
(10) Pub. No.: US 2008/0226851 A1
(43) Pub. Date: Sep. 18, 2008

(54) Gas barrier packaging board

(75) Inventors: Dwayne M. Shearer, Seattle, WA (US); George M. Fox, Longview, WA (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: Weyerhaeuser Co., Federal Way, WA (US)

(21) Appl. No.: 11/687,228

(22) Filed: Mar. 16, 2007

(51) Int. Cl. B32B 27/10

(52) U.S. Cl. 428/34.2

(57) ABSTRACT

A paperboard structure having a four layer product side construction of a tie layer, a gas barrier layer comprising at least one of aliphatic nylon, aromatic nylon, a blend of nylons, a copolymer of nylons and a blend of nylon with polyethylene terephthalate, a tie layer and a polyolefin layer.

The field is packaging board. More specifically it is a packaging board that may be formed into cartons and cups and has gas barrier properties.

The need for a gas barrier in paperboard packages is well known and there have been many solutions to reduce gas transfer through the paperboard. The amount and rate of gas transfer will depend on the type of harrier layer or layers that is used. The gas barrier layer is either laminated, extruded or co-extruded onto the paperboard to provide a board with gas barrier properties.

There are other factors that enter into the choice of a barrier material. Cost is a factor, both in the type and cost of the barrier material being used and also in the amount required to obtain the necessary barrier properties. Other important factors are carton durability, pinholes, and plastic char. Nylon in direct contact with an extruder die lip generates char (pyrolyzed nylon), and this char must be removed periodically to prevent contamination of the board. Char removal requires shutting down the extruder. The amount of barrier material required is also dependent on the uniformity of the barrier layer in both the machine direction and cross machine direction. Poor uniformity yields thick and thin spots which will change the gas barrier level. The type of material will also determine the amount of power required to extrude the material and therefore is a factor in the total cost of the packaging board.

Another factor is the adhesion of the material to the paperboard. Some materials adhere better than others. Some materials, such as nylon, require special board surface treatment to obtain adhesion to the paperboard. This also is reflected in the cost.

There is also the problem of pinholes. Pinholes are small holes in the plastic film that allow liquid contained in the container to contact and penetrate the paperboard. Wet paperboard is very weak and leads to poor durability and reduced shelf life. Pinholes occur when the plastic film is heated in a sealing operation. Heat generates steam in the paperboard and the steam generates bubbles in the plastic structure. Some of the bubbles burst and form pinholes. The number of pinholes can be greatly reduced if the low density polyethylene or linear low density polyethylene or other polyolefin flows into the bubble area thus sealing any pinholes.

Extrusion or co-extrusion is a faster, lower cost process than lamination. The cost of a laminate film and associated handling is also avoided with co-extrusion.

The present invention is directed to a cost effective gas barrier structure which has four layers on the product side and uses aromatic and aliphatic nylon and nylon blends and copolymers, and nylon blends with other polymers such as PET as the gas barrier.

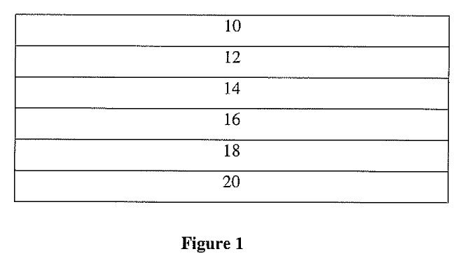

FIG. 1 is a cross-sectional view of the board.

The paperboard 12 has a first side and a second side opposite the first side. The paperboard may have a weight of 200 to 500 g/m².

A polyolefin layer 10 is applied to the outer or first surface of the paperboard 12. A typical outer polyolefin layer 10 is low density polyethylene. Layer 10 provides a good print surface. If improved carton durability is required then linear low density polyethylene, metallocene catalyzed linear low density polyethylene or a blend of low density polyethylene and linear low density polyethylene or metallocene catalyzed linear low density polyethylene may be used. These resins are tougher than low density polyethylene resins. Layer 10 is applied in amounts ranging from 15 to 25 grams per square meter (g/m²).

A first tie layer 14 is applied directly to the inner or second surface of the paperboard 12. The first tie layer has a first side and a second side opposite the first side. The first side of the tie layer 14 is applied directly to the inner or second surface of the paperboard 12. The first tie layer 14 may be any appropriate adhesive resin. A typical adhesive resin is a maleic anhydride modified polyethylene resin. Bynel® may be used as a tie layer. Bynel® may be a modified ethylene vinyl acetate, a modified ethylene acrylate, an anhydride modified high-density polyethylene, an anydride modified linear low density polyethylene, an anhydride modified low density polyethylene or an anhdydride modified polypropylene. Surlyn® may be used as a tie layer. Surlyn® is a partial sodium or magnesium salt of an ethylene/methacrylic acid copolymer. The usual amount of tie resin would be 3 to 9 grams per square meter.

The purpose of using the tie layer between the paperboard 12 and the nylon gas barrier 16 is to get better adhesion between the barrier layer and the paperboard than would be obtained by placing the barrier layer directly on the paperboard. Nylon barrier layers have been placed directly on the paperboard but a number of process steps on the board are required to obtain good adhesion. Using a tie layer is a cheaper and more convenient way of obtaining adhesion. In some constructions a polyethylene layer and a tie layer are placed between the paperboard and the nylon layer. The present construction obtains good adhesion without the cost of a polyethylene layer. When the layers are coextruded the tie layer also separates the nylon from the die lip, reducing the need to shut down the extruder for periodic cleaning of nylon char from the die lip.

The gas barrier layer 16 is applied directly to the first tie layer 14. The gas barrier layer 16 has a first side and a second side opposite the first side. The first side of layer 16 is applied directly to the second side of layer 14.

Various material may be used as a gas barrier material. Nylons may be used as the gas barrier layer. The nylons may be aliphatic nylons, aromatic nylons, blends of aliphatic nylons, blends of aromatic nylons, blends of aliphatic and aromatic nylons or copolymers of various nylons. Nylon may also be blended with other materials such as polyethylene terephthalate. Typical aliphatic nylons are nylon 6, nylon 66, nylon 6/66, nylon 6/9, nylon 6/10, nylon 11, nylon 12. Typical aromatic nylons are MXD6 or 6T-nylon.

The amount of gas barrier material ranges from 5 to 15 grams per square meter. The amount will determine the gas barrier property.

A second tie layer 18 is applied directly to the gas barrier layer 16. The second tie layer has a first side and a second side opposite the first side. The first side of the tie layer 18 is applied directly to the second side of gas barrier layer 16. The second tie layer 18 may be any appropriate adhesive resin. The second tie layer may be of the same material as the first tie layer. The usual amount of tie resin would be 3 to 9 grams per square meter.

An inner polyolefin layer 20 is applied directly to the tie layer 18. The inner polyolefin layer has a first side and a second side. The first side of the polyolefin layer 20 is applied directly to the second side of tie layer 18. The inner polyolefin product contact layer 20 is usually low density polyethylene. If higher durability is required then linear low density polyethylene, metallocene catalyzed linear low density polyethylene or a blend of low density polyethylene and linear low density polyethylene or metallocene catalyzed linear low density polyethylene may be used. The amount of polyethylene may range from 12 to 40 grams per square meter.

Pinhole performance is improved significantly by concentrating all of the low density polyethylene or metallocene catalyzed linear low density polyethylene in one layer, as opposed to two layers as are used in some barrier structures. The single higher basis weight layer promotes flow and re-sealing of pinholes caused by heating.

Although preferred embodiments of the invention have been described using specific terms, such description is for illustrative purposes only. The words used are words of description rather than of limitation. It is to be understood that changes and variations may be made by those of ordinary skill in the art without departing from the spirit or scope of the present invention, which is set forth in the following claims. The spirit and scope of the appended claims should not be limited to the description of the preferred versions contained herein.

1. A paperboard with gas barrier properties comprising
paperboard having a first side and a second side opposite the first side,
a first tie layer having a first side and a second side opposite said first side, the first tie layer first side being applied directly to the second side of the paperboard,
a gas barrier layer having a first side and a second side opposite the first side, the gas barrier layer first side being applied directly to said second side of the first tie layer second side, the gas barrier comprising at least one of aliphatic nylon, aromatic nylon, a blend of nylons, a copolymer of nylons and a blend of nylon with polyethylene terephthalate,
a second tie layer having a first side and a second side opposite the first side, the second tie layer first side being applied directly to the second side of the nylon layer, and
a polyolefin layer having a first side and a second side opposite the first side, the first side being applied directly to the tie layer first side.

2. The paperboard of claim 1 wherein the first tie layer, the gas barrier layer, the second tie layer and the polyolefin layer are co-extruded.

3. The paperboard of claim 1 wherein the polyolefin layer comprises low density polyethylene.

4. The paperboard of claim 1 wherein the polyolefin layer comprises metallocene catalyzed linear low density polyethylene

5. The paperboard of claim 1 wherein the nylon is at least one of nylon 6, nylon 66, nylon 6/66, nylon 6/9, nylon 6/10, nylon 11 and nylon 12,

6. The paperboard of claim 1 wherein the aromatic nylon comprises MXD6.

7. The paperboard of claim 1 wherein the blend of nylon and polyethylene terephthalate is a blend of aromatic nylon and polyethylene terephthalate.

8. The paperboard of claim 7 wherein the aromatic nylon is MXD6.

9. The paperboard of claim 1 further comprising a second layer of polyolefin having a first side and a second side, the first side of the polyolefin layer being attached directly to the first side of the paperboard.

10. The paperboard of claim 9 wherein the second polyolefin layer comprises low density polyethylene.

11. The paperboard of claim 9 wherein the second polyolefin layer comprises metallocene catalyzed linear low density polyethylene.
